(19) United States
(12) Patent Application Publication
(10) Pub. No.: US 2019/0213147 A1
(43) Pub. Date: Jul. 11, 2019

(54) STORAGE SYSTEM AND MAPPING METHOD

(71) Applicant: Hitachi, Ltd., Tokyo (JP)

(72) Inventors: Hirotoshi AKAIKE, Tokyo (JP); Masakuni AGETSUMA, Tokyo (JP)

(21) Appl. No.: 16/333,640

(22) PCT Filed: May 22, 2017
(86) PCT No.: PCT/JP2017/019039

§ 371 Date: Mar. 15, 2019

(51) Int. Cl. G06F 13/16; G06F 13/42

(52) U.S. Cl. CPC G06F 13/1668; G06F 2213/0026; G06F 13/4282

(57) ABSTRACT

A storage system, which is configured to separately create a device file corresponding to each device in the system and to access based on a bus number of a bus of a corresponding device connection destination stored in the device file, the device corresponding to the device file, is configured to create a latest bus tree information indicating a connection relationship between each bus and each device in the system, to separately detect, based on the latest created bus tree information, a bus number of a bus of each device connection destination, and to change the bus number of the bus of the corresponding device connection destination respectively described in each device file or to re-create each device file, based on a detection result.

### TECHNICAL FIELD

The present invention relates to a storage system and a mapping method, and is suitably applied to, for example, Software-Defined Storage (SDS).

### BACKGROUND ART

The SDS is a software-based storage system that executes processing similar to that of a storage controller in a storage system on a general purpose server. Efficiency of operation can be achieved and a server system can be built at a low cost by combining virtualization technology of the SDS and the server, virtualizing a plurality of servers and storage systems, and then putting together the same in the general purpose server.

In the SDS, regardless of a hardware configuration of the storage system, it is necessary to recognize a storage device, and a method of making a physical label correspond to a logical name for each storage device (hereinafter, simply referred to as device) is important. A program used in the SDS controls the storage device by accessing a device file corresponding to the logical name.

In general, the logical name is specified by using a hardware address (Media Access Control (MAC) address, etc.) as the physical label, thereby corresponding to a case where a device is added.

However, when the device is replaced, correspondence between the physical label and the logical name is changed, and the existing device, the replaced device, or the added device may not be correctly recognized in some cases. The program used in the SDS may access an unintended device file and may not be able to control the device as intended.

Therefore, a user of a computer system may need to manually make the physical label correspond to the logical name.

In order to solve such a problem, for example, PTL 1 discloses an invention that queries a hardware configuration and allocates a logical name to a device based on a bus address and a hardware address (MAC address, etc.).

### PRIOR ART LITERATURE

### Patent Literature

PTL 1: US Patent Application Publication 2013/0204987 specification

### SUMMARY OF INVENTION

### Technical Problem

However, the invention disclosed in the PTL 1 mainly assumes a case where the device replaced or added is a network apparatus. Therefore, in a case where another device is dependently connected is not considered, allocation of the logical name to the device is not intended for a device other than the network apparatus, and the allocation may not be applicable.

Specifically, there may be a case where a plurality of apparatuses are connected to one device by Peer to Peer (P2P) bridge connection of Peripheral Component Interconnect Express (PCIe), and a plurality of paths (buses) connected to the device are present. In this case, the bus number is shifted, and the intended logical name cannot be allocated to the intended device, and the invention of the PTL 1 cannot be applied.

Therefore, when a device is added or the device is replaced, the unintended logical name is allocated to the unintended device by applying related technique only. As a result, the intended device cannot be accessed, loss of data may occur, and there is a problem of a system having low reliability.

The invention is made in view of the above circumstances, and an object of the invention is to propose a storage system and a mapping method that can build an information processing system having high reliability.

### Solution to Problem

In order to solve such a problem, the invention provides a storage system, which is configured to separately create a device file corresponding to each device in the system and to access, based on a bus number of a bus of a corresponding device connection destination stored in the device file, the device corresponding to the device file, includes: a bus tree information creation unit configured to create bus tree information indicating a connection relationship between each bus and each device in the system; a connection relationship detection unit configured to separately detect, based on the latest bus tree information created by the bus tree information creation unit, a bus number of a bus of each device connection destination; and a mapping unit configured to change the bus number of the bus of the corresponding device connection destination respectively described in each device file or to re-create each device file, based on a detection result of the connection relationship detection unit.

Further, the invention provides a mapping method, which is a method of mapping between a device and a device file, and is executed in a storage system configured to separately create the device file corresponding to each device in the system and to access, based on a bus number of a bus of a corresponding device connection destination stored in the device file, the device corresponding to the device file, includes: a first step of creating a latest bus tree information indicating a connection relationship between each bus and each device in the system; a second step of separately detecting, based on the latest created bus tree information, a bus number of a bus of each device connection destination; and a third step of changing the bus number of the bus of the corresponding device connection destination respectively described in each device file or re-creating each device file, based on a detection result.

Further, the invention provides a storage system, which includes a storage controller configured to separately create a device file corresponding to each device in the system and to access, based on a bus number of a bus of a corresponding device connection destination stored in the device file, the device corresponding to the device file, and includes a disk enclosure connected to the storage controller. The storage controller includes a memory in which a program and each device file are stored, and a processor configured to control operation of the entire storage controller based on the program stored in the memory. The disk enclosure includes a network switch having an upstream bridge and one or a plurality of downstream bridges, the upstream bridge being connected to the storage controller, and one or a plurality of devices including a memory device respectively connected to the different downstream bridge in the network switch via the bus. The processor of the storage controller is configured to create a latest bus tree information indicating a connection relationship between each bus and each device in the system based on the program stored in the memory, to separately detect for each device, based on the latest created bus tree information, a correspondence relationship among an identifier of the upstream bridge to which the device is connected in the network switch, a device number of the downstream bridge to which the device is connected in the network switch, and a device name of the device, to separately detect a bus number of a bus of each device connection destination based on the detected correspondence relationship and the latest bus tree information, and to change the bus number of the bus of the corresponding device connection destination respectively described in each device file or to re-create each device file, based on a detection result.

According to the storage system and the mapping method of the invention, even when a configuration of the storage system is changed due to replacement or addition of the device, the desired device can be reliably accessed.

### Advantageous Effect

According to the invention, it is possible to implement a storage system and a mapping method that can build an information processing system having high reliability.

### BRIEF DESCRIPTION OF DRAWINGS

FIG. 1 is a block diagram showing a configuration of an information processing system according to an embodiment.

FIG. 2 is a block diagram showing a PCIe connection configuration in the information processing system of FIG. 1.

FIG. 3 is a conceptual diagram that explains bus tree information.

FIG. 4 is a block diagram showing a logical configuration of the information processing system according to this embodiment.

FIG. 5 is a block diagram that explains a problem of the related art.

FIG. 6 is a table showing a configuration of a device name registration table.

FIG. 7 is a table showing a configuration of a bus number/device name correspondence identification table.

FIG. 8 is a flowchart showing a processing procedure of device name registration processing.

FIG. 9 is a flowchart showing a processing procedure of bus number/device name correspondence processing.

FIG. 10 is a block diagram showing another embodiment.

FIG. 11 is a block diagram showing the other embodiment.

### DESCRIPTION OF EMBODIMENTS

Hereinafter, an embodiment of the invention is described in detail with reference to the drawings.

### (1) Configuration of Information Processing System According to this Embodiment

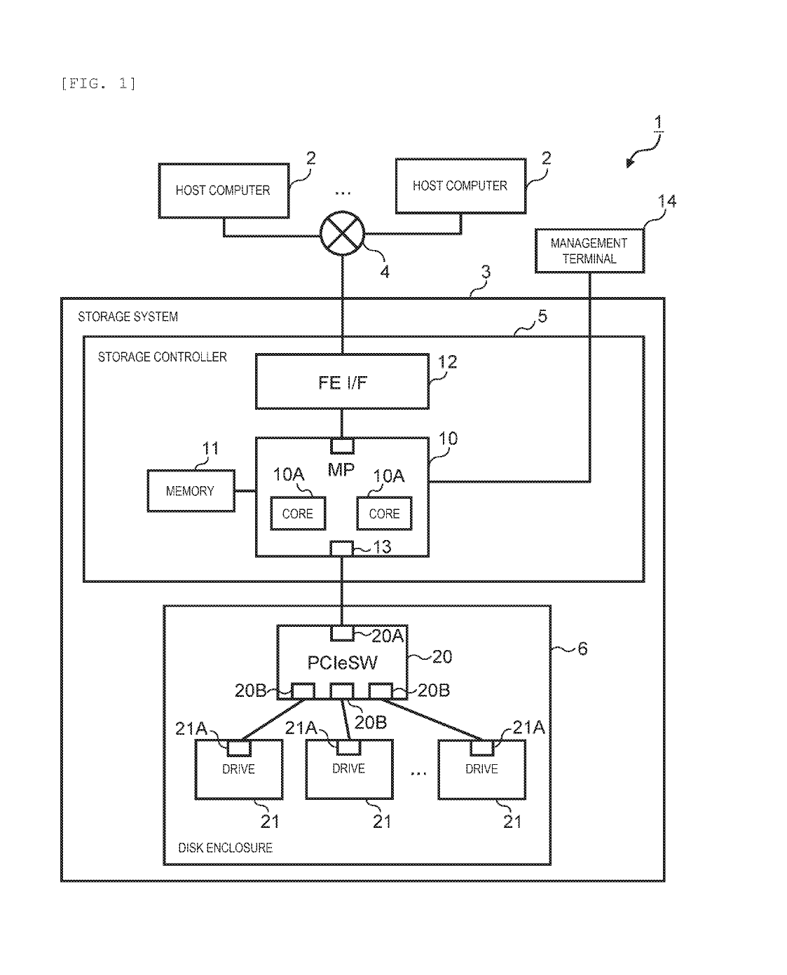

In FIG. 1, 1 shows an information processing system according to this embodiment as a whole. The information processing system 1 includes one or a plurality of host computers 2 and a storage system 3. The one or the plurality of host computers 2 and the storage system 3 are connected to each other via a network 4 including a Local Area Network (LAN) or an internet or the like.

The host computer 2 is a computer device including information resources such as a Central Processing Unit (CPU) and a memory, and includes, for example, an open-system server, and a mainframe computer or the like. The host computer 2 transmits a write command or a read command to the storage system 3 via the network 4 in response to a user operation or a request from an installed program.

The storage system 3 includes a storage controller 5 and one or a plurality of storage devices 6 connected (added) to the storage controller 5. Hereinafter, a case where a disk enclosure is applied as the storage device 6 is described. Hereinafter, the storage device 6 is referred to as the disk enclosure 6.

The storage controller 5 is a general purpose server device on which software necessary for providing the host computer 2 with a function as an SDS is mounted, and includes a microprocessor 10, a memory 11, a front-end interface 12, and a storage device (not shown).

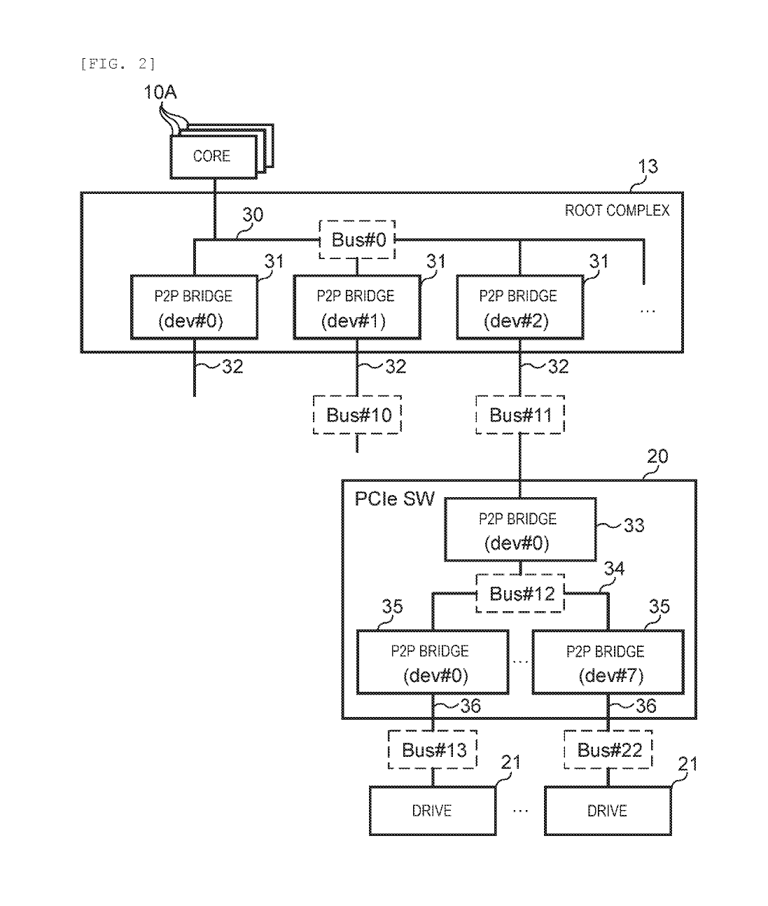

The microprocessor 10 is hardware that controls an overall operation of the storage controller 5, and includes one or a plurality of processor cores 10A and a root complex 13 to be described below with reference to FIG. 2. In response to the read command or the write command given by the host computer 2, each processor core 10A reads and writes data from or to the corresponding storage device in the storage controller 5 or the corresponding disk enclosure 6 via the root complex. The root complex 13 functions as an uppermost portion of an I/O layer that connects a subsystem such as the microprocessor 10, the memory 11, and the disk enclosure 6 to an I/O device.

The memory 11 includes, for example, a semiconductor memory such as a Synchronous Dynamic Random Access Memory (SDRAM), and is used for memorizing and holding a necessary program (including an Operating System (OS)) and data. The program stored in the memory 11 is executed by the processor core 10A of the microprocessor 10, so that various kinds of processing as the SDS are executed by the storage controller 5. However, for ease of understanding, a description will proceed on an assumption that such a program is executed by the microprocessor 10.

The front-end interface 12 is an interface with respect to the host computer 2, and performs protocol control during communication with the host computer 2 via the network 4.

The disk enclosure 6 is a memory device where a PCIe switch 20 and one or a plurality of drives 21 are mounted on one blade substrate or accommodated in one housing. The PCIe switch 20 is a switch conforming to a PCIe standard, and includes one upstream port 20A and a plurality of downstream ports 20B. The upstream port 20A is connected to the storage controller 5 via a cable, and the downstream port 20B is connected to a port 21A of any one of the drives 21 in the disk enclosure 6.

The drive 21 is a memory device or a memory medium that memorizes and holds data given by the host computer 2. In addition to a NAND flash memory, the drive 21 includes various kinds of memory devices or memory media such as a hard disk device, a Solid State Drive (SSD), a Magnetoresistive Random Access Memory (MRAM), a phase-change memory, a Resistance RAM (ReRAM), a Ferroelectric RAM (FeRAM), a magnetic disk, or an optical disk. Each drive 21 is given a logical name (hereinafter, referred to as a device name) that is unique to the drive 21 and is set by a user.

A management terminal 14 is also connected to the microprocessor 10 of the storage controller 5. The management terminal 14 includes, for example, a notebook personal computer, and is used when an administrator performs various kinds of settings and maintenance with respect to the storage controller 5.

FIG. 2 shows a PCIe connection configuration in the storage system 3. As shown in FIG. 2, each core 10A of the microprocessor 10 is separately connected to the root complex 13 in this storage system 3.

The root complex 13 includes a plurality of PCI Express to PCI Express bridges (P2P bridges) 31 connected via a PCIe bus 30. The disk enclosure 6 or a Network Interface Card (NIC) is connected to these P2P bridges 31 via PCIe buses 32 as necessary. The P2P bridge 31 may be a virtual bridge (virtual P2P bridge).

A device number (“dev#0” to “dev#3” in FIG. 2) unique to the P2P bridge 31 in the PCIe bus 30 to which the P2P bridge 31 is connected is given to each P2P bridge 31 by the microprocessor 10 through a function of a Basic Input/Output System (BIOS).

Meanwhile, the PCIe switch 20 of the disk enclosure 6 includes an upstream P2P bridge 33 and a plurality of downstream P2P bridges 35 connected to the upstream P2P bridge 33 via a PCIe bus 34.

The upstream P2P bridge 33 is connected to any one of the P2P bridges 31 in the root complex 13 of the microprocessor 10 via the PCIe bus 32, and the downstream P2P bridge 35 is connected to the drive 21 via a PCIe bus 36. Unique device numbers (“dev#0”, “dev#0” to “dev#7” in FIG. 2) in the PCIe buses 32, 34 on the upstream side to which the upstream P2P bridge 33 or the downstream P2P bridge 35 are connected are respectively given to the upstream P2P bridge 33 and each downstream P2P bridge 35 by the microprocessor 10 through the function of the BIOS.

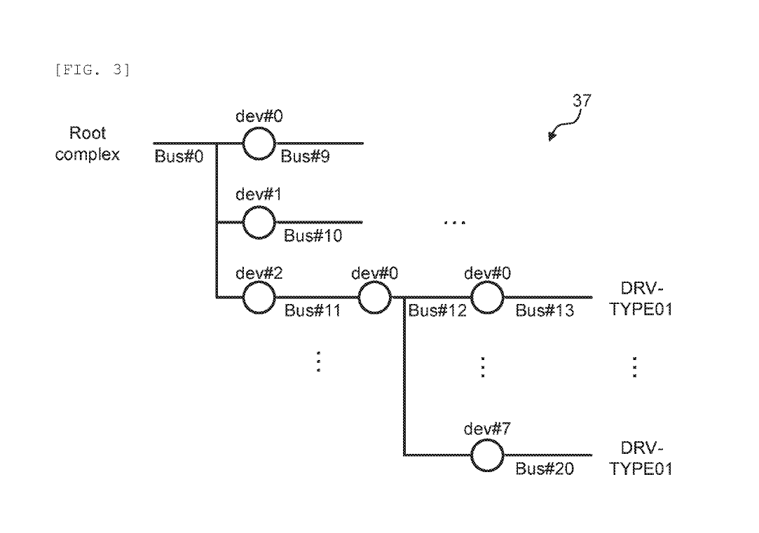

In the information processing system 1 having such a configuration, a bus number is given to each of the PCIe buses 30, 32, 34 and 36 in the storage system 3 by the microprocessor through the function of the BIOS. In practice, the microprocessor 10 separately collects information about all the PCI buses 30, 32, 34, and 36 in the storage system 3 and all the devices connected thereto from these devices when the storage system 3 (accurately, the storage controller 5) is started or restarted. Then, the microprocessor 10 generates bus tree information 37 as shown in FIG. 3 based on these collected information, and gives the bus numbers to the PCI buses 30, 32, 34 and 36 respectively based on the generated bus tree information 37.

Here, the bus tree information 37 is information having a tree structure indicating a connection relationship between each PCI bus and each device that are present in the storage system 3, and is created by the microprocessor 10 through an OS function after the storage controller 5 is started or restarted.

For example, in the case of FIG. 3 that is the bus tree information 37 of the storage system 3 having configurations of FIGS. 1 and 2, it is shown that a PCIe bus (the PCIe bus 30 in FIG. 2) to which a bus number “BUS#0” is given is connected to the root complex (“Root complex”) of the microprocessor 10, and devices (the P2P bridges 31 in FIG. 2) to which device numbers “dev#0, dev#1, dev#2, . . . ” are respectively given are connected to the above-described PCIe bus.

In an example of FIG. 3, it is shown that a device (the upstream P2P bridge 33 in FIG. 2) to which the device number “dev#0” is given is connected to a device to which the device number “dev#2” is given via a PCIe bus (the PCIe bus 32 in FIG. 2) to which a bus number “Bus#11” is given, and devices (the downstream P2P bridges 35 in FIG. 2) to which the device numbers ranging from “dev#0” to “dev#7” are respectively given are connected to the above-described device via a PCIe bus (the PCIe bus 34 in FIG. 2) to which a bus number “Bus#12” is given.

Further, in the example of FIG. 3, it is shown that devices (drives 21 in FIG. 2) to which device names “DRV-TYPE 01” are respectively given are connected to the above-described devices via PCIe buses (the PCIe buses 36 in FIG. 2) to which bus numbers ranging from “Bus#13” to “Bus#20” are respectively given.

### (2) Logical Configuration of Information Processing System According to this Embodiment

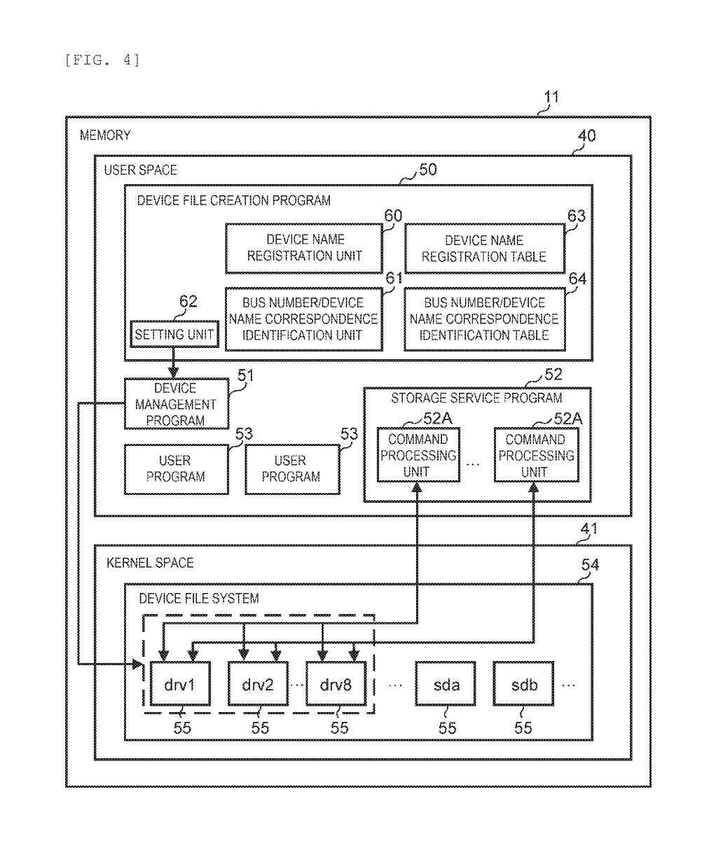

FIG. 4 shows a logical configuration of the storage controller 5. As shown in FIG. 4, in the storage controller 5 according to this embodiment, a user space 40 and a kernel space 41 are ensured in a memory space provided by the memory 11.

The user space 40 is an address space in which user programs are stored. In this embodiment, a device file creation program 50, a device management program 51, a storage service program 52, and a user program 53 are stored in the user space 40.

The device file creation program 50 is a program having a function of, after the storage controller 5 is started or restarted, detecting a bus number of the PCIe bus to which each device in the storage system 3 is respectively connected and notifying the device management program 51 of information indicating a connection relationship between these devices and the PCIe buses. The device file creation program 50 is described in detail below.

The device management program 51 is a program having a function of dynamically creating a device file 55 of each device in the storage system 3 such as Userspace Device management (udev), for example, in the case of Linux (registered trademark) and allocating the device file 55 to the device. In practice, the device management program 51 gives an instruction to the OS so as to create the device file 55 with respect to each device and allocate the device file 55 to the corresponding device based on the information which is given by the device file creation program 50 and indicates the connection relationship between the device and the PCIe bus described above. Thus, a kernel of the OS creates the corresponding device file 55 in the kernel space 41 in response to such an instruction.

The storage service program 52 is a program having a function of controlling reading/writing of data with respect to the drive 21 (FIG. 1) connected to the storage controller 5, and includes one or a plurality of command processing units 52A as functional units. The command processing unit 52A transmits commands, such as a read request or a write request corresponding to a read command or a write command from the host computer 2 (FIG. 1), to the corresponding device file 55.

The user program 53 is a program not related to storage management such as an application program that performs numerical calculation, and an application program that manages a database.

Meanwhile, the kernel space 41 is a virtual memory area in which a kernel of a not shown OS mounted on the storage controller 5 is present, and includes a device file system 54. The device file system 54 manages each device file 55 (“drv 1” to “drv 8”, . . . , “sda”, “sdb”, . . . ) associated with each device in the storage system 3 created by the above-described kernel.

The device files 55 are files that control the devices in the storage system 3, respectively. Each device file 55 stores information such as necessary information about a type or performance of the corresponding device, and a bus number of the PCIe bus to which the device is connected. In FIG. 4, “sda”, “sdb” or the like indicates a device file with respect to a device conforming to a Small Computer System Interface (SCSI) standard.

In a case where a command is given from the command processing unit 52A to the device file 55, a device driver (not shown) corresponding to the device file 55 in the kernel of the OS is started. Then, the device driver reads out a bus number of a PCIe bus of a corresponding device connection destination from the device file 55, and executes necessary processing such as read processing or write processing with respect to a corresponding device connected to the above-described PCIe bus of the bus number.

### (3) Mapping Function According to this Embodiment

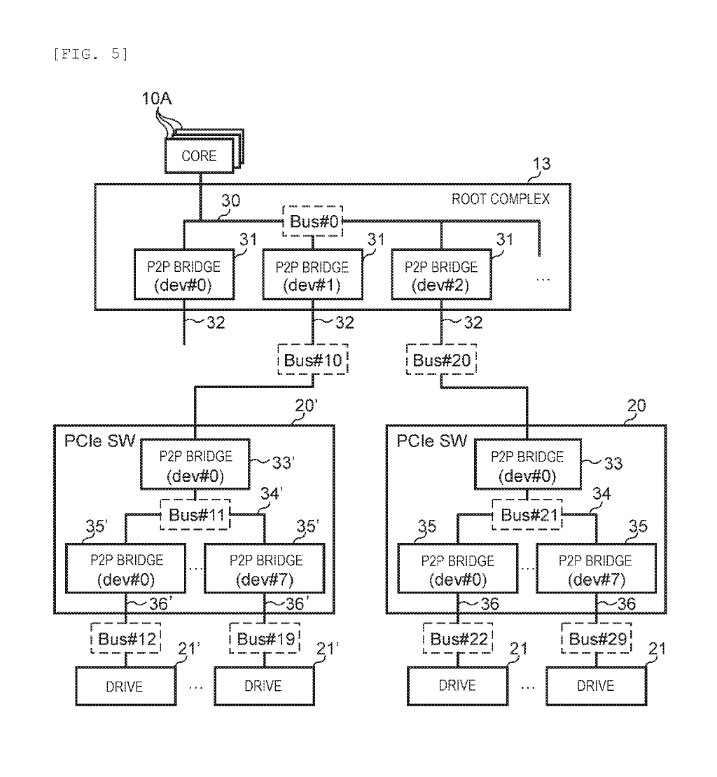

In FIG. 5, corresponding parts of FIG. 2 are given by the same reference numerals or the same reference numerals given “′”. FIG. 5 shows a state where, with respect to the storage system 3 having the configuration of FIG. 1, a disk enclosure (hereinafter, referred to as additional disk enclosure) having the same configuration as the disk enclosure 6 described above in FIG. 1 is newly connected to the P2P bridge 31 to which a device number “dev#1” of the root complex 13 of the microprocessor 10 (FIG. 1) is given.

FIG. 5 shows an example in which the microprocessor 10 of the storage controller 5 gives a bus number “Bus#11” to a PCIe bus 34′ that is located between an upstream P2P bridge 33′ and each downstream P2P bridge 35′ and is set in the PCIe switch 20′ of the additional disk enclosure, and respectively gives a bus number ranging from “Bus#12” to “Bus#19” to each PCIe bus 36′ connected between each downstream P2P bridge 35′ and each drive 21′ when the storage controller 5 is restarted after the additional disk enclosure is added.

As apparent from the comparison between FIG. 5 and FIG. 2, a bus number of the PCIe bus 32, which connects the P2P bridge 31 of the root complex 13 to which a device number “dev#2” is given and the disk enclosure 6 originally connected to the above-described P2P bridge 31, is changed to a bus number “Bus#20” as the additional disk enclosure is added.

A bus number of the PCIe bus 34 is also changed to a bus number “Bus#21” with the PCIe bus 34 disposed in the PCIe switch 20 of the disk enclosure 6 and located between the upstream P2P bridge 33 and each downstream P2P bridge 35. Bus numbers of the PCIe buses 36 connecting between the downstream P2P bridges 35 and the drive s21 are also changed to bus numbers ranging from “Bus#22” to “Bus#29”, respectively.

Accordingly, in a case where the disk enclosure 6 is added to the storage controller 5 of FIGS. 1 and 2, the bus number of the PCIe bus 36 of a drive 21 connection destination which is originally connected to the storage controller 5 may be changed.

Accordingly, in a case where the bus number of the PCIe bus 36 of the connection destination of the drive 21 which is originally connected to the storage controller 5 is changed, there is a problem that the bus number of the PCIe bus 36 of the drive 21 connection destination described in the device file 55 (FIG. 4) corresponding to the drive 21 does not match a bus number of the PCIe bus 36 of the actual drive 21 connection destination, and thus the device driver (eventually the command processing unit 52A (FIG. 4) of the storage service program 52 (FIG. 4) or the host computer 2 (FIG. 1)) corresponding to the drive 21 cannot access the drive 21 correctly.

Therefore, the information processing system according to this embodiment has a function (hereinafter, refers to as mapping function) of detecting a latest correspondence relationship (latest relationship between each device and each PCIe bus) between each device in the storage system 3 and a PCIe bus to which the device is connected, by using the latest bus tree information 37 (FIG. 3) created after the storage device is finally started or restarted, and performing mapping of each device and each device file by changing the bus number of the PCIe bus of the corresponding device connection destination stored in each device file 55 to a bus number of a PCIe bus of a latest connection destination based on a detection result.

In practice, the storage controller 5 creates the latest bus tree information 37 after being started or restarted. For each device in the storage system 3, the storage controller 5 then detects, by using the bus tree information 37, a correspondence relationship among an identifier (hereinafter, referred to as serial number of the upstream P2P bridge 33) unique to the upstream P2P bridge 33 (FIG. 2) to which the device is connected in the PCIe switch 20 (FIG. 2), a device number of the downstream P2P bridge 35 (FIG. 2) to which the device is connected in the PCIe switch 20, and a device name of the device.

Based on the latest bus tree information 37 and the detected correspondence relationship among the identifier, the device number and the device name, the storage controller 5 detects a correspondence relationship between the device name of each device and the bus number of the PCIe bus to which the device is connected after the storage controller 5 is started or restarted.

Thereafter, the storage controller 5 changes the bus number of the PCIe bus of the corresponding device connection destination respectively set in each device file 55 (FIG. 4) on the basis of the correspondence relationship of each device detected in this manner.

As a means for implementing the mapping function according to this embodiment as described above, as shown in FIG. 4, the device file creation program 50 sets a device name registration unit 60, a bus number/device name correspondence identification unit 61, and a setting unit 62 as functional units. Further, the device file creation program 50 includes a device name registration table 63 and a bus number/device name correspondence identification table 64.

The device name registration unit 60 is a functional unit having a function of detecting a connection relationship (correspondence relationship among the device name of the device, the device number of the downstream P2P bridge 35 (FIG. 2) to which the device is connected in the PCIe switch 20, and an identifier of the upstream P2P bridge 33 (FIG. 2) in the PCIe switch 20) between each device presenting in the storage system 3 and the PCIe switch 20 (FIG. 2) based on the latest bus tree information 37 (FIG. 3), which is generated by the microprocessor 10 (FIG. 1) after the storage controller 5 is started or restarted as described above, and of registering and managing the detected connection relationship in the device name registration table 63.

The bus number/device name correspondence identification unit 61 is a functional unit having a function of detecting the correspondence relationship between the device name of the device and the PCIe bus to which the device is connected for each device presenting in the storage system 3 based on the latest bus tree information 37 and the device name registration table 63, and separately registering and managing the detected connection relationship of each device in the bus number/device name correspondence identification table 64.

The setting unit 62 is a functional unit having a function of notifying the device management program 51 of the correspondence relationship of each device between the bus number and the device name stored in the bus number/device name correspondence identification table 64 created by the bus number/device name correspondence identification unit 61. Based on the correspondence relationship of each device between the bus number and the device name notified from the setting unit 62, the device management program 51 changes the bus number of the PCIe bus of the corresponding device connection destination set in each device file 55 to a latest bus number.

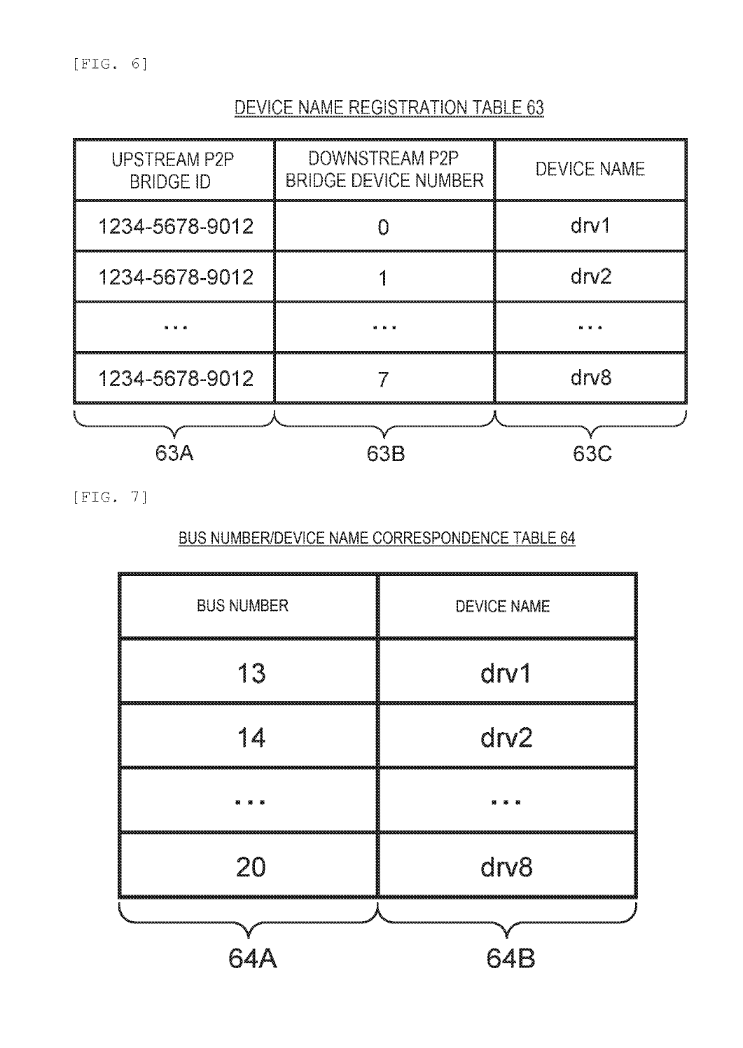

Meanwhile, the device name registration table 63 is a table used for managing the latest connection relationship between the device and the PCIe switch 20 (FIG. 2) as described above, and includes an upstream P2P bridge ID column 63A, a downstream P2P bridge device number column 63B, and a device name column 63C as shown in FIG. 6. In the device name registration table 63, one entry (one row) indicates one connection relationship.

The device name column 63C stores a name (device name) separately set by a user of each device presenting in the storage system 3. The downstream P2P bridge device number column 63B stores the device number of the downstream P2P bridge 35 (FIG. 2) to which the device is connected in the PCIe switch 20 (FIG. 2) to which the corresponding device is connected.

Further, the upstream P2P bridge ID column 63A stores the serial number as the identifier (ID) of the upstream P2P bridge 33 (FIG. 2) in the PCIe switch 20 which includes the corresponding downstream P2P bridge 35.

Therefore, in the example of FIG. 6, it is shown that a device having a device name “drv1” is connected to the downstream P2P bridge 35 to which a device number “0” is given in the PCIe switch 20 including the upstream P2P bridge 33 having a serial number “1234-5678-9012”.

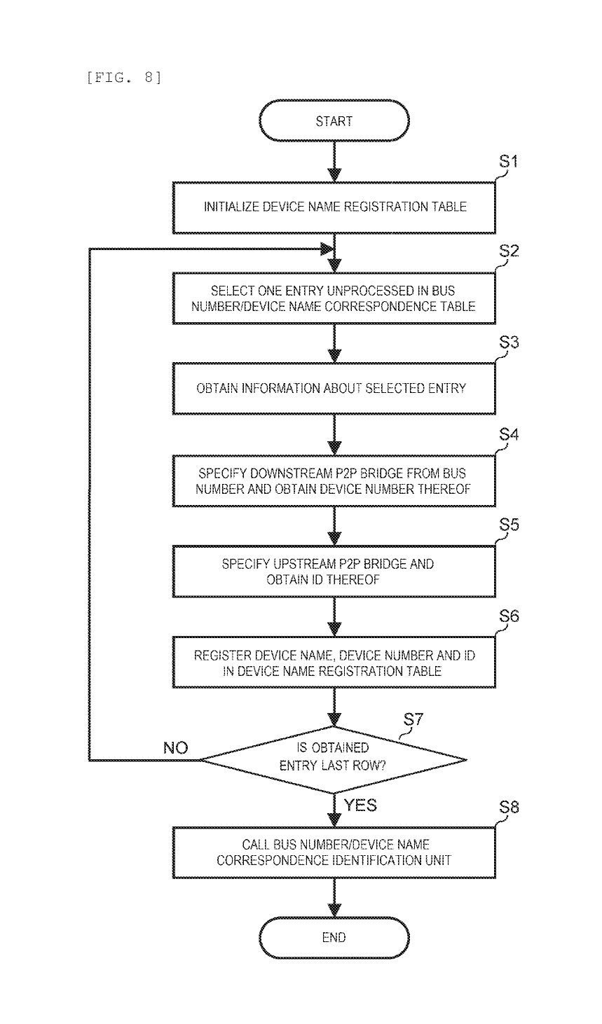

The bus number/device name correspondence identification table 64 is a table used for managing the latest connection relationship between the device and the PCI bus as described above, and includes a bus number column 64A and a device name column 64B as shown in FIG. 7. In the bus number/device name correspondence identification table 64, one entry (row) indicates the connection relationship between one device and one PCI bus.

The device name column 64B stores a device name of each device presenting in the storage system 3. The bus number column 64A stores a bus number given by the microprocessor 10 (FIG. 1) to the PCIe bus to which the corresponding device is connected.

Therefore, in the example of FIG. 7, it is shown that a device having a device name “drv1” is connected to a PCIe bus to which a bus number “13” is given, and a device having a device name “drv2” is connected to a PCIe bus to which a bus number “14” is given.

Initial values of the bus number/device name correspondence identification table 64 (FIG. 7) are set in the storage controller 5 by a user via the management terminal 14. Even in a case where a new device is added, a device name of the device and a bus number of a PCIe bus to which the device is connected are set by a user in the storage controller 5 via the management terminal 14.

### (4) Various Kinds of Processing Executed in the Storage Controller

Next, contents of various kinds of processing executed in the storage controller 5 in relation to the mapping function are described. Hereinafter, processing entities of various kinds of processing are described as the device name registration unit 60, the bus number/device name correspondence identification unit 61, or the setting unit 62 of the device file creation program. 50 (FIG. 4), but it is needless to say that the processor core 10A of the microprocessor 10 actually executes the processing based on the device file creation program 50.

### (4-1) Device Name Registration Processing

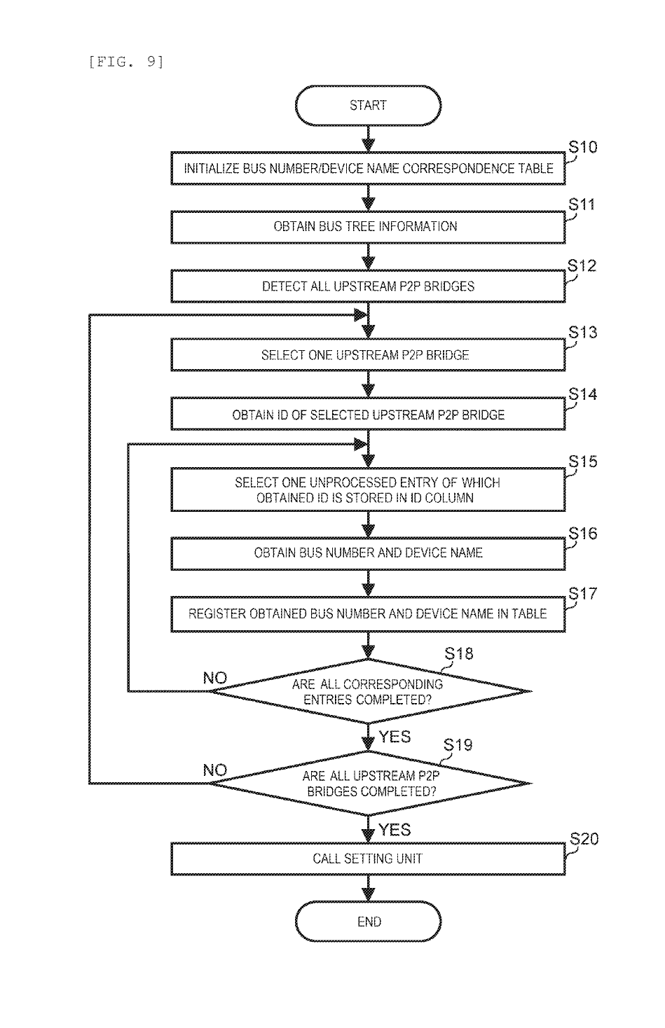

FIG. 8 shows a flow of device name registration processing executed by the device name registration unit 60. This device name registration processing is started when the storage controller 5 is started or restarted, and then the bus tree information 37 (FIG. 3) is generated by the microprocessor 10.

When this device name registration processing is started, the device name registration unit 60 first initializes the device name registration table 63 (FIG. 6) (S1). Specifically, for example, the device name registration unit 60 respectively overwrites each of the columns 63A to 63C of each entry in the device name registration table 63 with “NULL” indicating that there is no information.

Subsequently, the device name registration unit 60 selects one unprocessed entry (row) from the bus number/device name correspondence identification table 64 (S2), and obtains information (the bus number and the device name) of the entry (S3).

Next, the device name registration unit 60 refers to the latest bus tree information 37, specifies the downstream P2P bridge 35 in the PCIe switch 20 of the connection destination of the device connected to the PCIe bus to which the bus number obtained in step S2 is given, and obtains the device number of the downstream P2P bridge 35 from the latest bus tree information 37 (S4).

The device name registration unit 60 refers to the bus tree information 37, specifies the upstream P2P bridge 33 in the PCIe switch 20 including the downstream P2P bridge 35 having the device number obtained in step S4, and obtains the identifier (ID) of the upstream P2P bridge 33 from the bus tree information 37 (S5).

Subsequently, the device name registration unit 60 registers the device name obtained in step S3, the device number obtained in step S4, and the ID obtained in step S5 that are in association with each other as one entry in the device name registration table 63 (FIG. 6) (S6).

Next, the device name registration unit 60 determines whether the processing of steps S2 to S6 is executed and completed for all the entries (rows) in the bus number/device name correspondence identification table 64 (S7). When a negative result is obtained in this determination, the device name registration unit 60 returns to step S2, and thereafter repeats the processing of steps S2 to S7 until a positive result is obtained in step S7.

Then, when a positive result is obtained in step S7 by executing and completing the processing of steps S2 to S6 for all the entries in the bus number/device name correspondence identification table 64, the device name registration unit 60 completes the device name registration processing after calling the bus number/device name correspondence identification unit 61 (S8), and sorting each entry in the bus number/device name correspondence identification table 64 in a manner that the same is arranged in a descending order of an identifier (ID) value of the upstream P2P bridge 33.

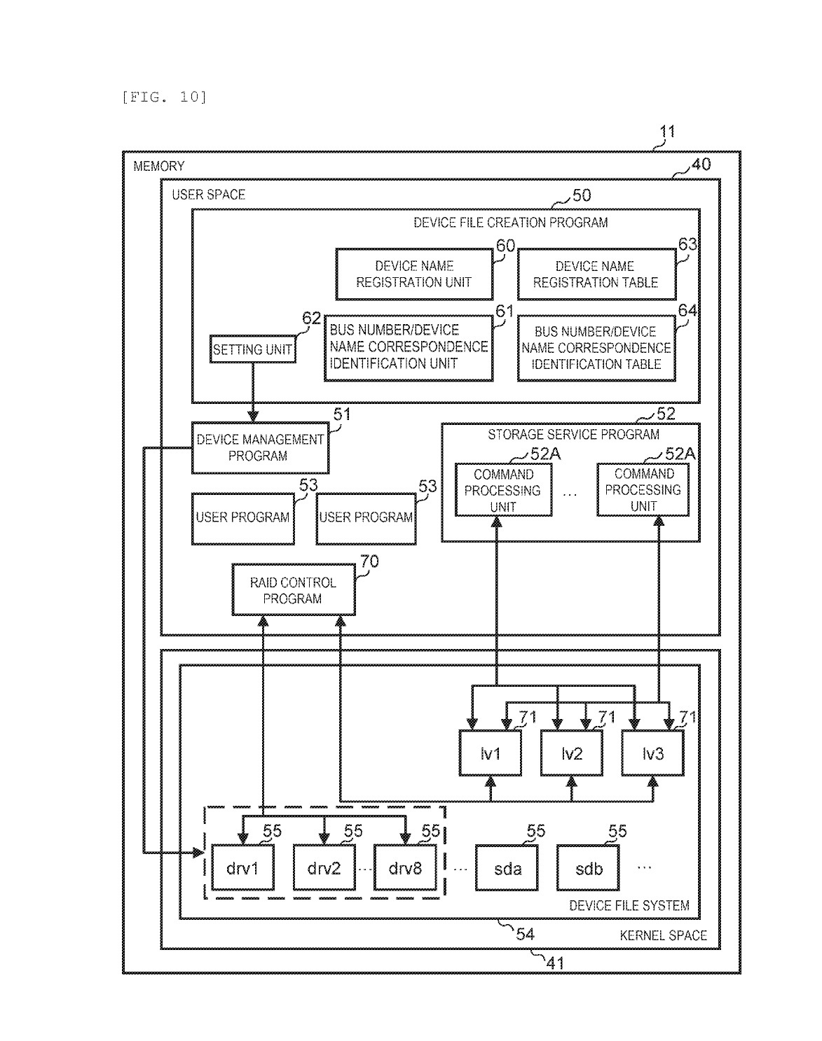

Accordingly, for each drive 21, the correspondence relationship among the identifier of the upstream P2P bridge 33 to which the drive 21 is connected in the PCIe switch 20, the device number of the downstream P2P bridge 35 to which the drive 21 is connected in the PCIe switch 20, and a drive name of the drive 21 is registered and managed in the device name registration table 63, so that bus number/device name correspondence processing to be described below with respect to FIG. 9 can be executed as appropriate when necessary.

### (4-2) Bus Number/Device Name Correspondence Processing

Meanwhile, FIG. 9 shows a flow of the bus number/device name correspondence processing executed by the bus number/device name correspondence identification unit 61 called in step S8 of the device name registration processing. When called by the device name registration unit 60, the bus number/device name correspondence identification unit 61 starts the bus number/device name correspondence processing shown in FIG. 9, and first initializes the bus number/device name correspondence identification table 64 (FIG. 7) (S10). Specifically, for example, the bus number/device name correspondence identification unit 61 respectively overwrites each of the columns 64A and 64B of each entry in the bus number/device name correspondence identification table 64 with “NULL”.

Subsequently, the bus number/device name correspondence identification unit 61 obtains the latest bus tree information 37 (S11), and detects all the upstream P2P bridges 33 in the storage system 3 based on the obtained bus tree information 37 (S12).

Next, the bus number/device name correspondence identification unit 61 selects one upstream P2P bridge 33 unprocessed in steps S14 to S18 from the detected upstream P2P bridges 33 (S13), and obtains the identifier (ID) of the upstream P2P bridge 33 from the bus tree information 37 (S14).

Subsequently, among the entries in the device name registration table 63 (FIG. 6), the bus number/device name correspondence identification unit 61 selects one entry unprocessed in steps S16 and S17, in which the identifier (ID) obtained in step S14 is stored in the upstream P2P bridge ID column 63A (FIG. 6) (S15).

Further, the bus number/device name correspondence identification unit 61 obtains a bus number corresponding to a device number stored in the downstream P2P bridge device number column 63B (FIG. 6) of the entry selected in step S15 (bus number of a bus connected to P2P bridge downstream side) and a device name stored in the device name column 63C (FIG. 6) of the entry (S16), associates the obtained bus number with the obtained device name, and registers them as one entry in the bus number/device name correspondence identification table 64 (FIG. 7) (S17).

The bus number/device name correspondence identification unit 61 determines, among all the entries in the device name registration table 63, whether the processing of steps S16 and S17 is executed and completed for all the entries in which the IDs obtained in step S14 are stored in the upstream P2P bridge ID column 63A (S18). When a negative result is obtained in this determination, the bus number/device name correspondence identification unit 61 returns to step S15, and then sequentially switches the entry selected in step S15 to another applicable unprocessed entry and repeats the processing of steps S15 to S18.

When an affirmative result is eventually obtained in step S18 by executing and completing, among the entries in the device name registration table 63, the processing of steps S16 and S17 for all the entries in which the IDs obtained in step S14 are stored in the upstream P2P bridge ID column 63A, the bus number/device name correspondence identification unit 61 determines whether the processing of steps S14 to S18 is executed and completed for all the upstream P2P bridges 33 detected in step S12 (S19).

When a negative result is obtained in this determination, the bus number/device name correspondence identification unit 61 returns to step S13, and then sequentially switches the upstream P2P bridge 33 selected in step S13 to another applicable unprocessed upstream P2P bridge 33 and repeats the processing of steps S13 to S19.

When a positive result is obtained in step S19 eventually by completing the processing of steps S14 to S18 for all the upstream P2P bridges 33 detected in step S12, the bus number/device name correspondence identification unit 61 completes the bus number/device name correspondence processing after calling the setting unit 62 (FIG. 4) (S20).

Then, the setting unit 62 called by the bus number/device name correspondence identification unit 61 separately notifies the device management program 51 (FIG. 4) of each correspondence relationship between the device name and the bus number registered in the bus number/device name correspondence identification table 64 created by the bus number/device name correspondence processing described above.

Thus, based on each notified correspondence relationship between the device name and the bus number, the device management program 51 updates the bus number of the PCIe bus of the corresponding device connection destination respectively stored in each device file 55 (FIG. 4) managed by the device file system 54 (FIG. 4) to the bus number of the PCIe bus of the latest connection destination.

### (5) Effects of this Embodiment

As described above, in the information processing system 1 according to this embodiment, the storage controller 5 of the storage system 3 detects the latest correspondence relationship (latest connection relationship between each device and the PCIe bus) between each device in the storage system 3 and the PCIe bus to which the device is connected by using the latest bus tree information 37 created after the storage controller 5 of the storage system 3 is started or restarted. Based on the detection result, the storage controller 5 of the storage system 3 changes the bus number of the PCIe bus of the corresponding device connection destination stored in each device file 55 to the bus number of the PCIe bus of the latest connection destination.

Therefore, according to the information processing system 1 of this embodiment, the device driver (eventually the command processing unit 52A of the storage service program 52 or the host computer 2) can reliably access a desired device and can consequently build an information processing system having high reliability even when configuration of the storage system 3 is changed due to replacement or addition of a device.

### (6) Other Embodiments

In the above-described embodiment, it is described that a serial number of the upstream P2P bridge 33 is applied as an identifier (ID) unique to the upstream P2P bridge 33, but the invention is not limited thereto, and a Universally Unique Identifier (UUID) can also be applied.

In the above-described embodiment, it is described that based on each correspondence relationship between a device name and a bus number notified by the setting unit 62, the device management program 51 updates a bus number of a PCIe bus of a corresponding device connection destination respectively stored in each device file 55 (FIG. 4) managed by the device file system 54 (FIG. 4) to a bus number of a PCIe bus of a latest connection destination. But the invention is not limited thereto, the device management program 51 may re-create each device file 55 based on each correspondence relationship between the device name and the bus number notified by the setting unit 62.

In the above-described embodiment, it is described that a bus tree information creation unit that creates the bus tree information 37 indicating a connection relationship between each PCIe bus and each device in a system includes the microprocessor 10 and an OS, a connection relationship detection unit that separately detects, based on the latest bus tree information 37 created by the bus tree information creation unit, a bus number of a PCIe bus of each device connection destination includes the microprocessor 10 and the device file creation program 50, and a mapping unit that changes, based on a detection result of the connection relationship detection unit, the bus number of the PCIe bus of the corresponding device connection destination respectively described in each device file 55 includes the microprocessor 10, the device file creation program 50 and the device management program 51. But the invention is not limited thereto, part or all of the bus tree information creation unit, the connection relationship detection unit and the mapping unit may include dedicated hardware.

In the above-described embodiment, it is described that the invention is applied to the information processing system 1 having a general configuration as shown in FIG. 1, but the invention is not limited thereto, and can be widely applied to information processing systems having various kinds of other configurations.

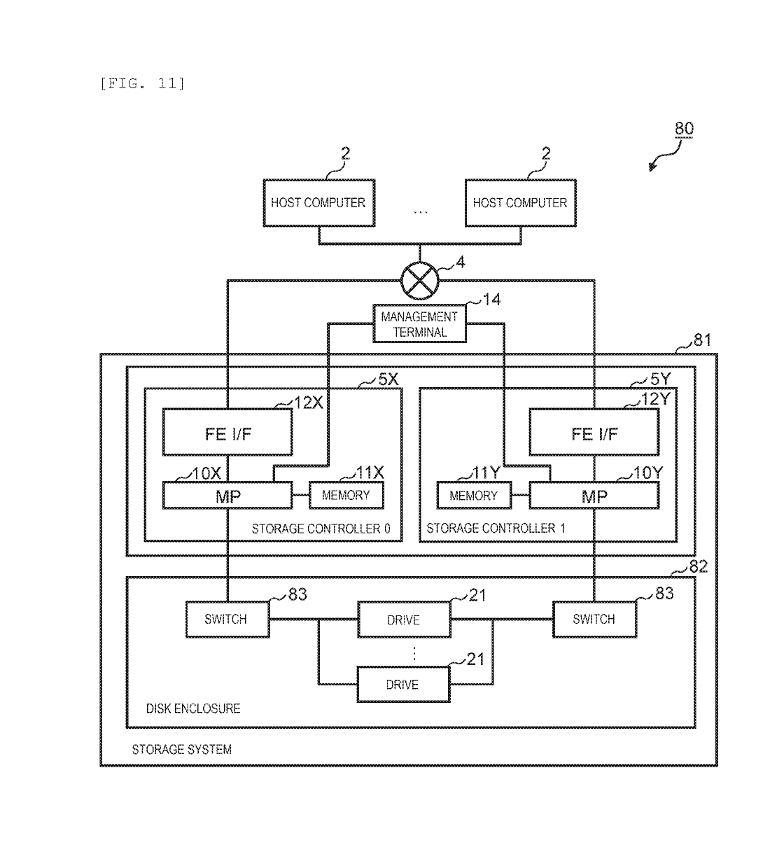

For example, as shown in FIG. 10 in which the same reference numerals are attached to corresponding parts of FIG. 4, the invention can also be applied to an information processing system in which a Redundant Arrays of Inexpensive Disks (RADI) control program 70 is stored in the user space 40 secured in a memory area provided by the memory 11, and the drive 21 (FIG. 1) is operated by the RAID control program 70 using the RAID method.

In such an information processing system, each command processing unit 52A of the storage service program 52 transmits a read/write request, in response to a read/write command from the host computer 2, to a corresponding logical volume 71. Then, the read/write request is transferred to the RAID control program 70, and is transferred under the control of the RAID control program 70 to the device file 55 of each device (the drive 21) that provides the memory area to the logical volume 71, and necessary read processing or write processing is executed by a corresponding device driver.

Further, as shown in FIG. 11 in which the same reference numerals or the same reference numerals with symbols “X” or “Y” are attached to the corresponding parts of FIG. 1, the invention can also be applied to an information processing system 80 having a configuration in which storage controller 5X and 5Y of a storage system 81 are made redundant.

In this case, two PCIe switches 83 are disposed in one disk enclosure 82, and the drive 21 is connected to each PCIe switch 83. With such a configuration, in a case where one of the two storage controller 5X or 5Y fails, the other storage controller 5Y or 5X can be used to correspond to the read command or the write command from the host computer 2.

In the information processing system 80 having the configuration of FIG. 11, the device name registration table 63 and the bus number/device name correspondence identification table 64 having the same configuration are stored in memories 11X and 11Y of the respective storage controller 5X and 5Y. Accordingly, respective microprocessors 10X and 10Y of the two storage controller 5X, 5Y can recognize each device having the same device name.

### REFERENCE SIGN LIST

1, 80 information processing system
2 host computer
3, 81 storage system
5, 5X, 5Y storage controller
6, 82 disk enclosure
10, 10X, 10Y microprocessor
10A core
11 memory
13 root complex
20 PCIe switch
21, 21′ drive
30, 32, 34, 34′, 36, 36′ PCIe bus
31 P2P bridge
33, 33′ upstream P2P bridge
35, 35′ downstream P2P bridge
37 bus tree information
50 device file creation program
51 device management program
52 storage service program
52A command processing unit
54 device file system
55 device file
60 device name registration unit
61 bus number/device name correspondence identification unit
62 setting unit
63 device name registration table
64 bus number/device name correspondence identification table

1. A storage system, which is configured to separately create a device file corresponding to each device in the system and to access the device corresponding to the device file based on a bus number of a bus of a corresponding device connection destination stored in the device file, comprising:
a bus tree information creation unit configured to create bus tree information indicating a connection relationship between each bus and each device in the system;
a connection relationship detection unit configured to separately detect the bus number of the bus of each device connection destination based on latest bus tree information created by the bus tree information creation unit; and
a mapping unit configured to change the bus number of the bus of the corresponding device connection destination described in each device file or to re-create each device file based on a detection result of the connection relationship detection unit.

2. The storage system according to claim 1,
wherein the bus tree information creation unit is configured to create the bus tree information after the system is started or restarted, and
the latest bus tree information is the bus tree information finally created after the system is started or restarted.

3. The storage system according to claim 2, further comprising:
a device name registration unit configured such that an identifier of an upstream bridge to which the device is connected in a network switch, a device number of a downstream bridge to which the device is connected in the network switch, and a device name of the device are made to correspond to each other and registered as device name registration information for each device.

4. The storage system according to claim 3,
wherein the connection relationship detection unit is configured to separately detect for each device, based on the latest bus tree information, a correspondence relationship among the identifier of the upstream bridge to which the device is connected in the network switch, the device number of the downstream bridge to which the device is connected in the network switch, and the device name of the device, and
separately detect the bus number of the bus of each device connection destination based on the detected correspondence relationship and the device name registration information.

5. The storage system according to claim 4, comprising:
a disk enclosure used for addition,
wherein the disk enclosure includes
the network switch, and
one or a plurality of devices including a memory device connected to each of the different downstream bridges in the network switch via the bus.

6. A mapping method, which is a method of mapping between a device and a device file and is executed in a storage system configured to separately create the device file corresponding to each device in the system and to access the device corresponding to the device file based on a bus number of a bus of a corresponding device connection destination stored in the device file, the mapping method comprising:
a first step of creating a latest bus tree information indicating a connection relationship between each bus and each device in the system;
a second step of separately detecting the bus number of the bus of each device connection destination based on the latest created bus tree information; and
a third step of changing the bus number of the bus of the corresponding device connection destination respectively described in each device file or re-creating each device file based on a detection result.

7. The mapping method according to claim 6,
wherein the bus tree information is created after the storage system is started or restarted, and
the latest bus tree information according to the second step is the bus tree information finally created after the system is started or restarted.

8. The mapping method according to claim 7,
wherein in the third step, an identifier of an upstream bridge to which the device is connected in a network switch, a device number of a downstream bridge to which the device is connected in the network switch, and a device name of the device are made to correspond to each other and registered as device name registration information for each device.

9. The mapping method according to claim 8,
wherein in the second step, based on the latest bus tree information, a correspondence relationship among the identifier of the upstream bridge to which the device is connected in the network switch, the device number of the downstream bridge to which the device is connected in the network switch, and the device name of the device is separately detected for each device, and
wherein the bus number of the bus of each device connection destination is separately detected based on the detected correspondence relationship and the device name registration information.

10. The mapping method according to claim 9,
wherein the storage system includes a disk enclosure for addition, and
the disk enclosure includes
the network switch; and
one or a plurality of devices including a memory device connected to each of the different downstream bridges in the network switch via the bus.

11. A storage system, which includes a storage controller configured to separately create a device file corresponding to each device in the system and to access the device corresponding to the device file based on a bus number of a bus of a corresponding device connection destination stored in the device file, and a disk enclosure connected to the storage controller,
wherein the storage controller includes
a memory in which a program and each device file are stored; and
a processor configured to control operation of the entire storage controller based on the program stored in the memory,
the disk enclosure includes
a network switch including an upstream bridge and one or a plurality of downstream bridges, the upstream bridge being connected to the storage controller; and
one or a plurality of devices including a memory device connected to each of the different downstream bridges in the network switch via the bus, and
the processor of the storage controller is configured to create a latest bus tree information indicating a connection relationship between each bus and each device in the system based on the program stored in the memory,
separately detect for each device, based on the latest created bus tree information, a correspondence relationship among an identifier of the upstream bridge to which the device is connected in the network switch, a device number of the downstream bridge to which the device is connected in the network switch, and a device name of the device,
separately detect the bus number of the bus of each device connection destination based on the detected correspondence relationship and the latest bus tree information, and
change the bus number of the bus of the corresponding device connection destination respectively described in each device file or to re-create each device file based on a detection result.
